(19) United States
(12) Patent Application Publication
(10) Pub. No.: US 2009/0026278 A1
(43) Pub. Date: Jan. 29, 2009

(54) SYSTEMS AND METHODS FOR USING A SHAPE MEMORY ALLOY TO CONTROL TEMPERATURE

(76) Inventor: Dan Latner, New York, NY (US)

Correspondence Address: Ruttler Law PLLC;One Union Square, 600 University Street, Suite 1919, Seattle, WA, 98101, US

(21) Appl. No.: 11/828,659

(22) Filed: Jul. 26, 2007

(51) Int. Cl. G05D 23/00

(52) U.S. Cl. 236/1 C

(57) ABSTRACT

This invention relates generally to shape memory alloys, and more specifically, to systems and methods for using a shape memory alloy to control temperature. In one embodiment, the invention includes obtaining a shape memory alloy (SMA) having a first shape; deforming the SMA to a second shape, the deformed SMA releasing thermal energy resulting in heat; distributing the heat from the SMA in a first direction; reforming the SMA to approximately the first shape, the reformed SMA consuming thermal energy resulting in cold; distributing the cold from the SMA in a second direction, the second direction being different from the first direction, wherein the first direction is towards a location whereby increased temperatures are desired and the second direction is towards a location whereby decreased temperatures are desired.

### FIELD OF THE INVENTION

This invention relates generally to shape memory alloys, and more specifically, to systems and methods for using a shape memory alloy to control temperature.

### BACKGROUND

A shape memory alloy (SMA) is commonly described as a metal that “remembers” its geometry. Indeed, an SMA can be mechanically deformed and returned to its original shape merely by the application of thermal energy, a process known as a phase transformation. This mechanical deformation and thermal-energy-induced reformation can be repeated many times over without significant fatigue. Normally, such a phase transformation would occur only when a metal is heated to its melting point, but an SMA extraordinarily undergoes this phase transformation while remaining solid at a temperature below its melting point.

The primary types of SMAs are copper-zinc-aluminum, copper-aluminium-nickel, and nickel-titanium (commonly known as Nitinol). However, there are many others including Ag—Cd, Au—Cd, Cu—Al—Ni, Cu—Sn, Cu—Zn, Cu—Zn—Si, Fe—Pt, Mn—Cu, Fe—Mn—Si, Pt, Co—Ni—Al, Co—Ni—Ga, Ni—Fe—Ga, and Ti—Pd. The temperature at which an SMA undergoes a phase transformation is dependent upon the elemental ratios of the alloy and can range anywhere between −50° to 166° C. Nitinol is the most popular SMA having a melting point around 1240° to 1310° C., a density of around 6.5 g/cm³, and exhibiting a corrosive resistance, a non-magnetic nature, and a high fatigue strength. There are also SMAs that undergo phase transformations under strong magnetic fields and shape memory polymers that similarly exhibit temperature-dependent phase transformations.

SMAs have been widely used for their temperature or magnetic induced mechanical changes in a number of fields including military, medical, safety, consumer, and robotics applications. For instance, Asada (U.S. patent application Ser. No. 11/557,779) discloses a system for providing controlled motion in an automobile seat using an SMA that changes shape upon application of thermal energy. Similarly, Kirkpatrick et al. (U.S. patent application Ser. No. 10/905,937) discloses a beam formed from an SMA that oscillates after application of thermal energy. Again, Yazawa et al. (U.S. patent application Ser. No. 09/994,175) discloses a method for applying thermal energy to an SMA and transferring the resulting mechanical energy to electrical energy. Further, Aase et al. (U.S. patent application Ser. No. 11/436,314) and Fukuda et al. (U.S. Pat. No. 4,541,326) disclose an SMA that changes its shape to alter an air flow path upon application of thermal energy. Additionally, Stefano et al. (U.S. Pat. No. 6,446,876) discloses an SMA that mechanically adjusts Venetian blinds upon application of thermal energy from an electrical source. Along a similar line, Li (U.S. Pat. No. 4,302,938) and Cory (U.S. Pat. No. 4,305,250) disclose an SMA that provides mechanical energy to a set of pulleys upon application of thermal energy from heated water. Also, Wang (U.S. Pat. No. 4,472,939) discloses a system whereby thermal energy is applied to an SMA to produce mechanical energy for driving a wheel. Lastly, Hart (U.S. Pat. No. 4,087,971), Golestaneh (U.S. Pat. No. 4,325,217), and Wechsler et al (U.S. Pat. No. 5,279,123) disclose an SMA that provides mechanical energy upon application of thermal energy. There are many other examples of similar systems that apply thermal energy to an SMA to produce mechanical motion, but noticeably absent in the art is reversibly using an SMA to control temperature.

One of the most common temperature control devices is the traditional air conditioner. Traditional air conditioners work on the principle of compressing a gas to generate heat and subsequently allowing the gas to expand and consume thermal energy thereby making it cold. The cold air is distributed in one direction and the hot air is distributed in the other. Traditional air conditioners suffer from many problems including requiring a tremendous amount of electrical energy for compression. The compressors themselves are large, bulky, noisy, expensive, and inefficient and generally only work in a limited temperature range. Additionally, the compressor gas often leaks or is incorrectly disposed of thereby harming the environment. Despite these severe disadvantages, this method of temperature control persists because there are no viable substitutes for the traditional air conditioner system.

Accordingly, although desirable results have been achieved, there exists much room for improvement. What are needed then are systems and methods for using a shape memory alloy to control temperature.

### SUMMARY

This invention relates generally to shape memory alloys, and more specifically, to systems and methods for using a shape memory alloy to control temperature. In one embodiment, the invention includes obtaining a shape memory alloy (SMA) having a first shape; deforming the SMA to a second shape, the deformed SMA releasing thermal energy resulting in heat; distributing the heat from the SMA in a first direction; reforming the SMA to approximately the first shape, the reformed SMA consuming thermal energy resulting in cold; distributing the cold from the SMA in a second direction, the second direction being different from the first direction, wherein the first direction is towards a location whereby increased temperatures are desired and the second direction is towards a location whereby decreased temperatures are desired.

### BRIEF DESCRIPTION OF THE DRAWINGS

Embodiments of the present invention are described in detail below with reference to the following drawings:

FIG. 1 is a block diagram of a method for using a shape memory alloy to control temperature, in accordance with an embodiment of the invention;

FIG. 2 is a perspective view of system for using a shape memory alloy to control temperature, in accordance with an embodiment of the invention;

FIG. 3 is a perspective view of a system for using a shape memory alloy to control temperature, in accordance with an embodiment of the invention;

FIG. 4 is a perspective view of a system for using a shape memory alloy to control temperature, in accordance with an embodiment of the invention; and

FIG. 5 is a perspective view of a system for using a shape memory alloy to control temperature, in accordance with an embodiment of the invention.

### DETAILED DESCRIPTION

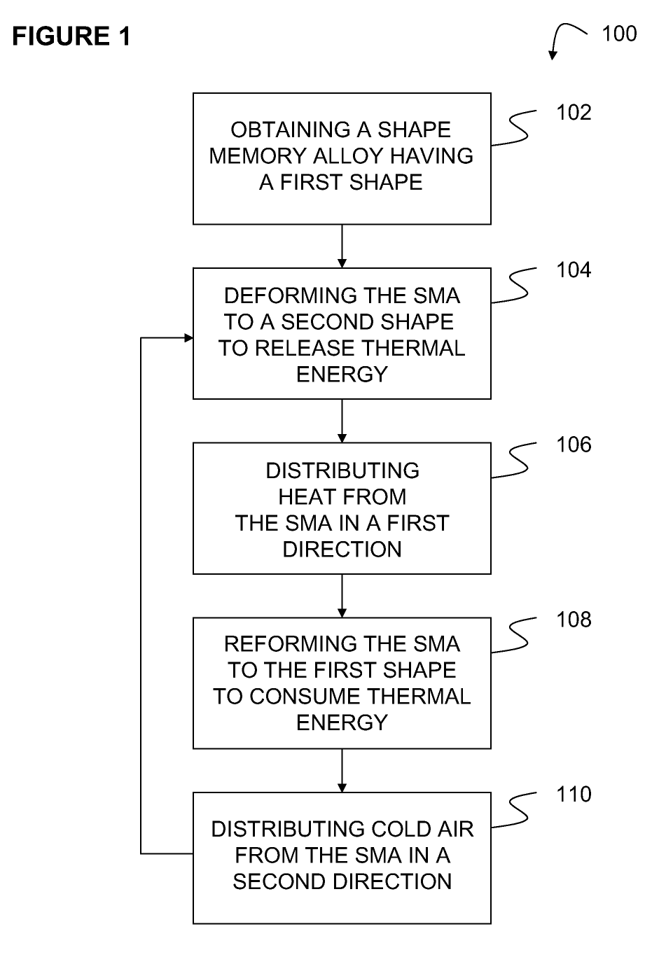

This invention relates generally to shape memory alloys, and more specifically, to systems and methods for using a shape memory alloy to control temperature. Specific details of certain embodiments of the invention are set forth in the following description and in FIG. 1-5 to provide a thorough understanding of such embodiments. The present invention may have additional embodiments, may be practiced without one or more of the details described for any particular described embodiment, or may have any detail described for one particular embodiment practiced with any other detail described for another embodiment.

FIG. 1 is a block diagram of a method for using a shape memory alloy to control temperature, in accordance with an embodiment of the invention. In one embodiment, method 100 includes obtaining a shape memory alloy (SMA) having a first shape at block 102, deforming the SMA to a second shape to release thermal energy at block 104, distributing heat from the SMA in a first direction at block 106, reforming the SMA to the first shape to consume thermal energy at block 108, and distributing cold from the SMA in a second direction at block 110.

As discussed herein, shape memory alloys have been used extensively for thermal induced mechanical operations. In these contexts, a shape memory alloy is deformed and returned to a previous position through the application of thermal energy. However, shape memory alloys also have another useful property in that they release thermal energy upon deformation and consume thermal energy upon reformation. This temperature change is not easily perceptible when the deformation and reformation occur relatively rapidly because the amount of energy released and consumed upon deformation and reformation is approximately equal. Thus, with rapid deformation and reformation a shape memory alloy releases a quantity of thermal energy and then quickly consumes approximately the same quantity of thermal energy making it difficult to perceive the temperature change. But the temperature change is certainly present and is more easily perceivable when the deformation and reformation are accomplished more slowly, such as at around 60 deformations/reformations per minute. When a shape memory alloy is deformed and held in the deformed state, a release of thermal energy can be felt in the form of heat. This release of thermal energy gradually subsides and the shape memory alloy eventually returns to room temperature. When the shape memory alloy is reformed to its original shape it consumes approximately the same amount of thermal energy that was released resulting in a feeling of cold. Gradually, the consumption of thermal energy subsides and the shape memory alloy returns to room temperature. This process can continue with the shape memory alloy releasing and consuming thermal energy upon each deformation and reformation. The present invention harnesses this property of shape memory alloys to control temperature.

In one embodiment, the obtaining an SMA having a first shape at block 102 includes selecting any SMA and defining its non-deformed parent shape. Various SMAs have already been discussed herein with common ones being copper-zinc-aluminum, copper-aluminum-nickel, and nickel-titanium (also known as Nitinol), any of which are selectable. Often a selected SMA will have a pre-defined non-deformed parent shape or first shape that is acceptable such as a rod, sheet, ball, cube, band, ring, or a belt. However, the non-deformed parent shape or first shape can also be changed by heating the selected SMA to a very high temperature such as to around 500° C., which varies based on the alloy composition. The deforming the SMA to a second shape to release thermal energy at block 104 includes mechanically altering the SMA from its first shape to a different second shape. For example, if the first shape is a rod then the second shape can be a bent rod. Alternatively, if the first shape is a ring then the second shape can be a compressed ring. The deformation of the SMA from a first shape to a different second shape releases thermal energy which results in increased temperatures or heat surrounding the deformed SMA. The distributing heat from the SMA in a first direction at block 106 includes removing the heat from the SMA to a first location where increased temperatures are desired or acceptable. The distribution of heat away from the SMA lowers the temperature surrounding the SMA towards room temperature. The reforming the SMA to the first shape to consume thermal energy at block 108 includes mechanically returning the SMA from the second shape to approximately the first shape. For example, if the second shape is a bent rod then the first shape can be a rod. Similarly, if the second shape is a compressed ring then the first shape can be a ring. The reformation of the SMA from the second shape to the first shape consumes thermal energy which results in decreased temperatures or cold surrounding the reformed SMA. The distributing cold air from the SMA in a second direction at block 110 includes removing the cold from the SMA to a second location where decreased temperatures are desired or acceptable. The distribution of cold away from the SMA increases the temperature surrounding the SMA toward room temperature. Method 100 can optionally return to block 104 and repeat to heat the first location or cool the second location as desired.

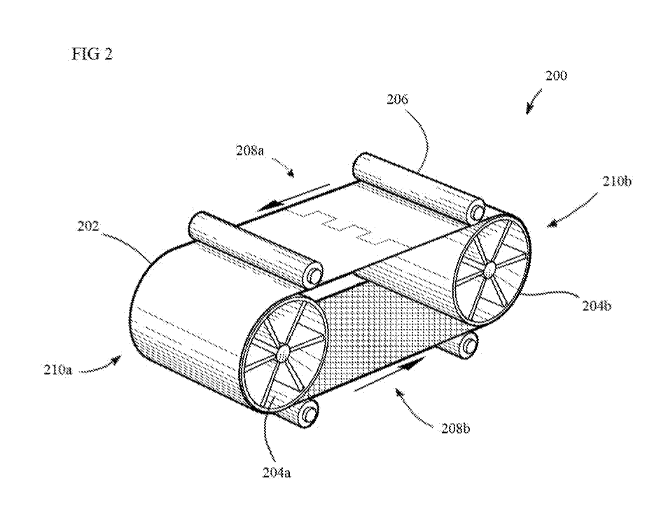

FIG. 2 is a perspective view of system for using a shape memory alloy to control temperature, in accordance with an embodiment of the invention. In one embodiment, system 200 includes a belt 202, a roller 204a, a roller 204b, and a plurality of sinks 206. The belt 202 forms a continuous loop that is formed from a substantially flat and elongated SMA that is coupled together along its distal edges. The belt 202 is non-cylindrical and defines opposing first shapes 208a and 208b that are relatively flat and opposing second shapes 210a and 210b that are relatively curved, the first shapes 208a and 208b being the non-deformed parent shapes and the second shapes 210a and 210b being the deformed shapes; although the opposite is also possible. The belt 202 circumscribes the rollers 204a and 204b, which are oppositely disposed against the inside surface of the belt 202 adjacent to the second shapes 210a and 210b, respectively. The plurality of sinks 206 rotatably rest along the surface of the belt 202. The belt 202 is configurable to circulate about the rollers 204a and 204b whereby the first shapes 208a and 208b are repeatedly deformed into the second shapes 210a and 210b, respectively, and whereby the second shapes 210a and 210b are repeatedly re-formed to the first shapes 208b and 208a, respectively. The plurality of sinks 206 are configurable to rotate in response to the circulation of the belt 202. In one particular embodiment, the belt 202 circulates at approximately 60 rotations per minute.

As the belt 202 circulates about the rollers 204a and 204b, thermal energy is released by the SMA when it is deformed into the second shapes 210a and 210b and thermal energy is consumed by the SMA when it is reformed into the first shapes 208a and 208b. The release of thermal energy creates heat that can be distributed in a first direction where increased temperatures are desired. Oppositely, the consumption of thermal energy creates cold that can be distributed in a second direction where decreased temperatures are desired. The plurality of sinks 206 are configurable to wick temperature changes away from the belt 202 to provide additional surface areas for more efficient heat and cold distribution. For example, during summer months the first direction can be outside a building and the second direction can be inside a building. Alternatively, during winter months the first direction can be inside a building and the second direction can be outside a building.

After significant usage, the belt 202 can experience structural fatigue and become less instrumental in controlling temperature. A support membrane, such as Mylar® webbing, can be introduced along the interior surface of the belt 202 to reduce such fatigue. Further, the belt 202 can be easily removable and replaceable with another consumable belt. Alternatively, the belt 202 can be thermally heated to high temperatures as discussed supra to re-establish the structural integrity of the shape memory alloy and redefine the non-deformed parent shape.

In an alternative embodiment, the shape of the belt 202 can be modified into any uniform or non-uniform geometric shape. For example, the belt can be in a form of one or more elongated rods or even triangular. In another embodiment, fewer or greater numbers of belts 202 can be employed. Thus, a plurality of belts having reduced widths can circumscribe a set of rollers. In yet a further embodiment, fewer or greater numbers of the rollers 204 can be employed or the rollers 204 can be alternatively shaped or disposed. For instance, rollers can be disposed at each of the vertices of a triangularly shaped belt. In a further embodiment, fewer or greater numbers of the plurality of sinks 206 can be employed or the plurality of sinks 206 can be alternatively disposed. Accordingly, sinks can be disposed against an interior or exterior surface of a belt, rollers, or even other sinks. In yet another embodiment, shape changes to an SMA can be magnetically induced or an SMA can be replaced with at least one shape memory polymer whereby shape changes are either mechanically or magnetically induced.

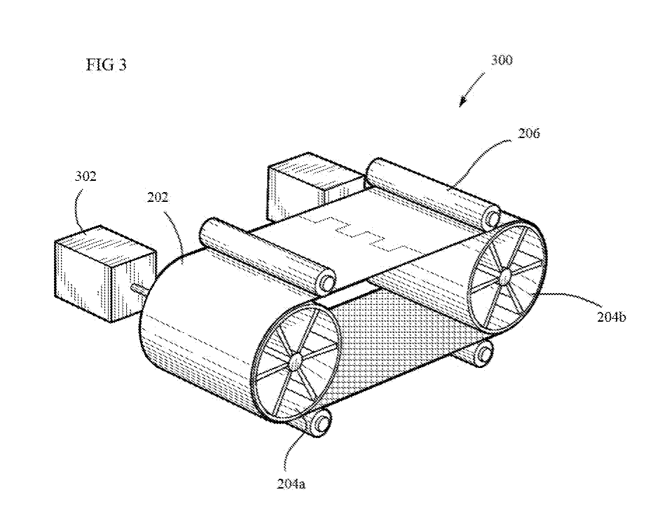

FIG. 3 is a perspective view of a system for using a shape memory alloy to control temperature, in accordance with an embodiment of the invention. In one embodiment, system 300 includes a belt 202, a roller 204a, a roller 204b, and a plurality of sinks 206 as described more fully in reference to FIG. 2 supra. To drive circulation of the belt 202 about the rollers 204a and 204b, a motor 302 providing rotational motion is coupled to an axle of the roller 204a. Rotational motion from the motor 302 is thereby transferred to the roller 204a and to the belt 202. The motor 302 can be a stepper motor, an electric motor, or any other type of motor. In an alternative embodiment, the motor 302 is coupled to an axle of the roller 204b, any of the plurality of sinks 206, or the belt 202. In certain embodiments, additional or fewer of motors are employable.

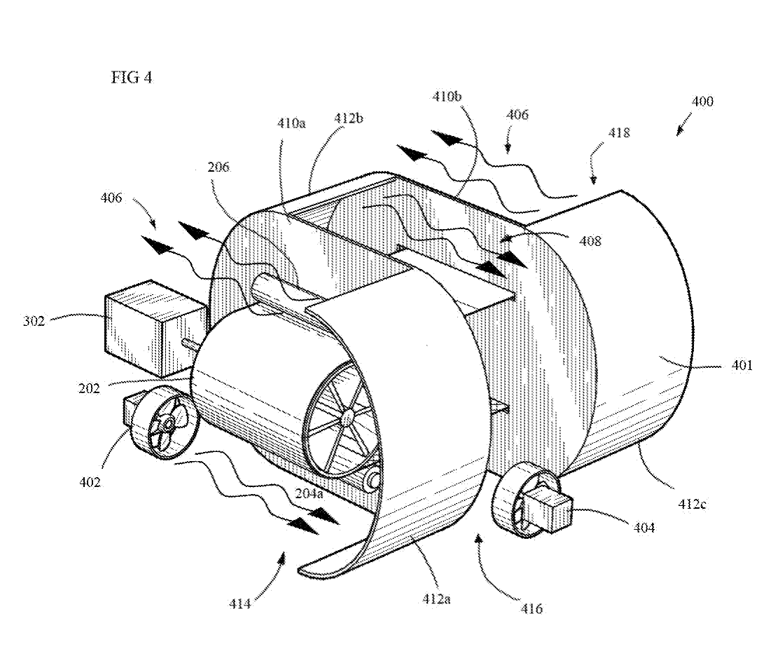

FIG. 4 is a perspective view of a system for using a shape memory alloy to control temperature, in accordance with an embodiment of the invention. In one embodiment, system 400 includes a belt 202, a roller 204a, a roller 204b (not visible), a plurality of sinks 206, and a motor 302 as described more fully in reference to FIGS. 2 and 3 supra. Also included in system 400 are baffles 401, a fan 402, a fan 404, and a fan 405 (not visible).

The baffles 401 are comprised of a first section 414, a second section 416, and a third section 418. The first section 414 is defined by a sidewall 410a and a concave surface 412a. The second section 416 is defined by the sidewall 410a, a concave surface 412b, and a sidewall 410b. The third section 418 is defined by the sidewall 410b and a concave surface 412c. The concave surfaces 412a and 412c are commonly aligned to direct airflow in a first direction 406 and the concave surface 412b is oppositely aligned to direct airflow in a second direction 408. The sidewalls 410a and 410b separate the first section 414, the second section 416, and the third section 418 from one another and define a plurality of apertures (not labeled) for receiving the belt 202. The roller 204a is disposed within the first section 414 while the roller 204b (not visible) is disposed within the third section 418. The plurality of sinks 206 can be disposed within any or all of the first section 414, the second section 416, and the third section 418. Accordingly, the belt 202 is partially exposed within each of the first section 414, the second section 416, and the third section and is configurable to circulate through each of the aforementioned sections via the plurality of apertures.

The fan 402 is positioned to direct airflow through or around the area of the belt 202 exposed within the first section 414 and towards the concave surface 412a. The concave surface 412a redirects the airflow from the fan 402 back through or around the area of the belt 202 exposed within the first section 414 in the first direction 406. The roller 204a and the plurality of sinks 206 can include one or more channels therein for increasing the surface area for which airflow may pass. Thus, the thermal energy released from the belt 202 is distributed in the first direction 406. Oppositely, the fan 404 is positioned to direct airflow through or around the area of the belt 202 exposed within the second section 416 and towards the concave surface 412b. The concave surface 412b redirects the airflow from the fan 404 back through or around the area of the belt 202 exposed within the second section 416 in the second direction 408. Thus, cold resulting from the thermal energy consumed by the belt 202 is distributed in the second direction 408. The fan 405 is positioned to direct airflow within the third section 418 substantially as described in reference to the fan 402 within the first section 414.

In one particular embodiment, the baffles 401 are omitted, alternatively shaped, or incongruous. In yet another embodiment, the fans 402, 404, and 405 can be supplemented by additional fans, reduced in number, repositioned, or replaced with an alternative methodology for directing airflow. In yet a further embodiment, airflow is replaced or supplemented with liquid flow or some other methodology for distributing heat or cold. In an alternate embodiment, the rollers 204a or 204b are alternatively positioned.

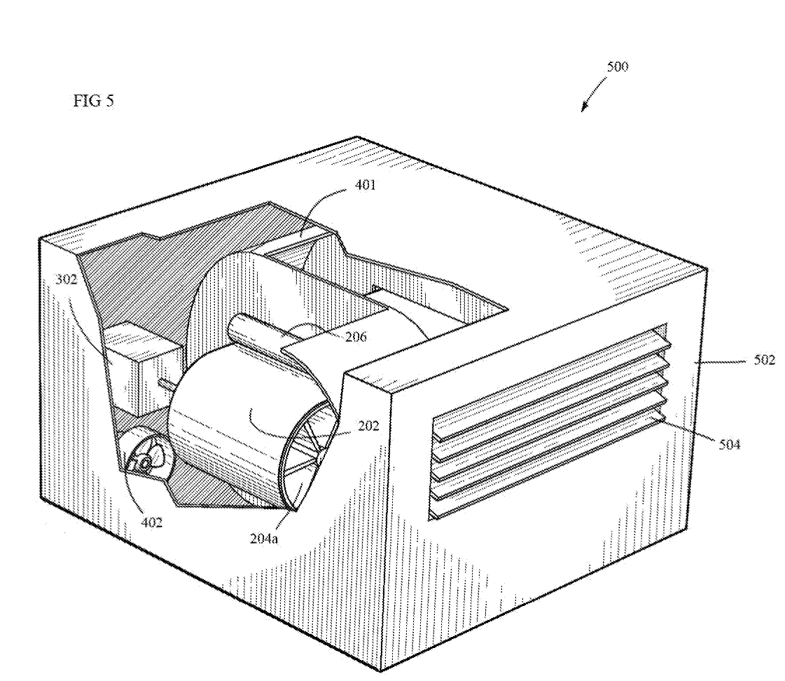

FIG. 5 is a perspective view of a system for using a shape memory alloy to control temperature, in accordance with an embodiment of the invention. In one embodiment, system 500 includes a belt 202, a roller 204a, a roller 204b (not visible), a plurality of sinks 206, and a motor 302, baffles 401, a fan 402, a fan 404 (not visible), and a fan 405 (not visible) as described more fully in reference to FIGS. 2, 3, and 4 supra. Also included in system 500 is a housing 502. The housing 502 is a rigid frame for encapsulating, storing, and protecting the aforementioned components. The housing 502 works in coordination with the baffles 401 to provide a seal and prevent airflow from transferring among the first section 414, the second section 416, and the third section 418. Vents 504 in the housing 502 provide a channel for incoming and outgoing airflow; although additional or fewer vents are employable.

Accordingly, system 500 is configurable to control temperature whereby air is drawn into the housing 502 within the second section 416 by the fan 404. The air is directed over the belt 202 exposed within this section, which is circulating and consuming thermal energy, thereby cooling the air. The concave surface 412b of the baffles 401 redirects the cooled air out of the housing 502 in the second direction 408. Oppositely, air is drawn into the housing 502 within the first section 414 and the third section 418 by the fans 402 and 405, respectively. The air is directed over the belt 202 exposed within these sections, which is circulating and releasing thermal energy, thereby heating the air. The concave surfaces 412a and 412c of the baffles 401 redirect the heated air out of the housing 502 in the first direction 406. System 500 is usable to control temperature in various settings such as a home, automobile, marine vessel, aircraft, business, or any other venue.

In certain embodiments, a control system is configurable to permit adjustability of the fans 402, 404, or 405 speeds, the belt 202 circulation speed, or other similar parameters. In a further embodiment, the housing 502 is differently shaped for aesthetic purposes or to more suitably function in combination with various embodiments described herein. In yet another embodiment, the vent 504 is replaced or supplemented with a duct or hose system permitting system 500 to be separated from areas for which temperature control is desired. In an alternate embodiment, any of the fans 402, 404, and 405 are moved outside of the housing 502 such as within a hose or duct system. In an additional embodiment, solar cells are installed proximate to the housing 502 to provide power the motor 302, the fans 402, 404, and 405, or any other power consuming device.

While preferred and alternate embodiments of the invention have been illustrated and described, as noted above, many changes can be made without departing from the spirit and scope of the invention. Accordingly, the scope of the invention is not limited by the disclosure of these preferred and alternate embodiments. Instead, the invention should be determined entirely by reference to the claims that follow.

What is claimed is:

1. A method for controlling temperature using a shape memory alloy, the method comprising the steps of:
obtaining a shape memory alloy (SMA) having a first shape;
deforming the SMA to a second shape, the deformed SMA releasing thermal energy resulting in heat;
distributing the heat from the SMA in a first direction;
reforming the SMA to approximately the first shape, the reformed SMA consuming thermal energy resulting in cold;
distributing the cold from the SMA in a second direction, the second direction being different from the first direction,
wherein the first direction is towards a location whereby increased temperatures are desired and the second direction is towards a location whereby decreased temperatures are desired.

2. The method of claim 1 wherein the SMA is any selected from a group consisting of copper-zinc-aluminum, copper-aluminum-nickel, and nickel-titanium.

3. The method of claim 1 wherein the deforming is accomplished by any of mechanical force, magnetic field, and a combination of mechanical force and magnetic field.

4. The method of claim 1 wherein the reforming is accomplished within approximately one second after the deforming.

5. The method of claim 1, further comprising the step of
when the SMA experiences structural fatigue, heating the SMA to approximately 500° C. to redefine the first shape.

6. The method of claim 1, wherein the SMA is substituted with a shape memory polymer (SMP).

7. A system for controlling temperature using a shape memory alloy, the system comprising:
a shape memory alloy (SMA) having a non-deformed parent shape; and
a mechanical device, the mechanical device being configurable to deform the SMA from the non-deformed parent shape to a deformed shape and the mechanical device being configurable to reform the SMA from the deformed shape to the non-deformed parent shape,
wherein the SMA releases thermal energy upon deformation and consumes thermal energy upon reformation.

8. The system of claim 7, wherein the SMA is a belt forming a continuous loop and the mechanical device comprises a first roller and a second roller, wherein the belt rollably circumscribes the first and second rollers, and wherein circulation of the belt about the first and second rollers is configurable to repeatedly deform the SMA from the non-deformed parent shape to the deformed shape and reform the SMA from the deformed shape to the non-deformed parent shape.

9. The system of claim 8, further comprising:
a first fan, the first fan positioned to direct air flow over the deformed shape of the SMA in a first direction; and
a second fan, the second fan positioned to direct air flow over the non-deformed parent shape of the SMA in a second direction,
wherein the first direction is towards a location where increased temperature is desired and the second direction is towards a location where decreased temperature is desired.

10. The system of claim 9, wherein at least one sink rotatably contacts any of the belt, the first roller, and the second roller to wick thermal energy changes away from the belt.

11. The system of claim 10, further comprising:
baffles, the baffles providing a structural barrier around the belt to prevent air flow that is directed over the deformed shape of the SMA from commingling with air flow that is directed over the non-deformed shape of the SMA.

12. The system of claim 11, further comprising
a support membrane, the support membrane being coupled to a surface of the SMA to reduce structural fatigue.

13. The system of claim 7, further comprising
a heat source, the heat source being disposed proximate to the SMA, the heat source configurable to periodically heat the SMA to a high temperature to redefine the non-deformed parent shape.

14. The system of claim 7 wherein the SMA is an elongated rod.

15. The system of claim 8 wherein circulation of the belt about the first and second rollers is induced by a motor and wherein the motor is solar powered.

16. The system of claim 9 wherein any of the first fan and the second fan is solar powered.

17. A system for controlling temperature using a shape memory alloy, the system comprising:
a shape memory alloy (SMA) having a non-deformed parent shape; and
a means for deforming the SMA from the non-deformed parent shape to a deformed shape and a means for reforming the SMA from the deformed shape to the non-deformed parent shape,
wherein the SMA releases thermal energy upon deformation and consumes thermal energy upon reformation.

18. The system of claim 17, further comprising:
a means for directing air flow over the deformed shape of the SMA in a first direction; and
a means for directing air flow over the non-deformed parent shape of the SMA in a second direction,
wherein the first direction is towards a location where increased temperature is desired and the second direction is towards a location where decreased temperature is desired.

19. The system of claim 18, further comprising:
a means for wicking thermal energy changes away from the SMA.

20. The system of claim 19, further comprising:
a means for preventing air flow that is directed over the deformed shape of the SMA from commingling with air flow that is directed over the non-deformed shape of the SMA.
